(19) United States
(12) Patent Application Publication
(10) Pub. No.: US 2006/0221000 A1
(43) Pub. Date: Oct. 5, 2006

(54) Plasma display apparatus and driving method thereof

(75) Inventor: Seonghak Moon, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 11/391,295

(22) Filed: Mar. 29, 2006

(30) Foreign Application Priority Data
Mar. 30, 2005 (KR) 10-2005-0026763

(51) Int. Cl. G09G 3/28

(52) U.S. Cl. 345/68

(57) ABSTRACT

A plasma display apparatus and a driving method thereof are provided. A plasma display apparatus according to an embodiment of the present invention comprises a plasma display panel comprising an electrode and an energy recovery/supply unit comprising a variable inductor located over a supply path of a pulse applied to the electrode. A driving method of a plasma display apparatus according to still another embodiment of the present invention comprises the steps of varying an inductance of an inductor over charging/discharging paths according to a screen pattern or load of a plasma display panel and making constant a rising/falling slope of the sustain pulse.

This Nonprovisional application claims priority under 35 U.S.C. § 119(a) on Patent Application No. 10-2005-0026763 filed in Korea on Mar. 30, 2005 the entire contents of which are hereby incorporated by reference.

### BACKGROUND OF THE INVENTION

1. Field of the Invention

This document relates to a display apparatus, and more particularly, to a plasma display apparatus and a driving method thereof.

2. Description of the Background Art

In general, a plasma display apparatus among display apparatuses comprises a plasma display panel and a driver for driving the panel.

Recently, various flat display devices have been developed whose weight and size, which are a shortcoming of cathode ray tube, can be reduced.

The flat display devices comprise a liquid crystal display(LCD), a field emission display(FED), a plasma display panel(PDP), an organic light emitting display(EL), etc.

The PDP, a display element using a gas discharge, has an advantage in that it can be manufactured as a large-sized panel.

Currently, a three-electrode AC surface type PDP is mainly used for most of PDPs, on an upper substrate of which are formed a scan electrode and a sustain electrode, and on a lower substrate is formed an address electrode.

The three-electrode AC surface type PDP is driven during plural separated subfield periods, and in each subfield period a gray scale is displayed by light-emitting by the numbers of time relative to a weight of video data.

At this time, the subfield period is, in turn, separated into an initialization period, an address period and a sustain period to drive the PDP.

Herein, the initialization period is for forming uniform wall charges on a discharge cell, the address period is for generating a selective address discharge according to a logic value of video data, and the sustain period is for sustaining an address discharge in a discharge cell where the address discharge is created.

A high voltage above a few hundred volts is needed to generate an address discharge and sustain discharge in the thusly driven three-electrode AC surface type PDP. Accordingly, an energy recovery device is employed to minimize a driving power needed to create an address discharge and sustain discharge in the PDP.

FIG. 1 is a circuit diagram showing an energy recovery device for a general PDP.

Referring to FIG. 1, energy recovery devices 2, 12 for a plasma display panel, suggested by ‘Weber(U.S. Pat. No. 5,081,400)’, are symmetrically installed with respect to a panel capacitor Cp.

Herein, the panel capacitor Cp represents equivalent capacitance formed between a scan electrode Y and sustain electrode Z of the PDP.

A first energy recovery device 2 supplies sustain pulses to the scan electrode Y, and a second energy recovery device 12, operated alternately with the first energy recovery device 2, supplies sustain pulses to the sustain electrode Z.

A construction of the energy recovery devices 2, 12 of a general PDP will be described below with reference to the first energy recovery device 2.

The first energy recovery device 2 comprises an energy recover/supply unit 4, a sustain voltage supply unit 6 and a ground voltage supply unit 8.

The energy recovery/supply unit 4 serves to recover energy of reactive power not to contribute to a discharge of the PDP during a sustain period, and at the same time to supply the recovered energy to the panel capacitor Cp.

The energy recovery/supply unit 4 comprises a source capacitor Cs1 for storing the recovered energy, a first inductor L1 connected between the source capacitor Cs1 and a second node N2, a common node between the sustain voltage supply unit 6 and ground voltage supply unit 8, a first switch SW1 and a first diode D1 connected in series between the source capacitor Cs1 and the first inductor L1 for forming a current path to supply the energy stored in the source capacitor Cs1 to the panel capacitor Cp, and a second diode D2 and a second switch SW2 connected in series between a first node N1, a common node between the first diode D1 and the first inductor L1, and the source capacitor Cs1 for forming a current path to recover energy of reactive power not to contribute to a discharge from the panel capacitor Cp.

The source capacitor Cs1 serves to recover and charge the voltage charged to the panel capacitor Cp during the sustain discharge, and at the same to re-supply the charged voltage to the panel capacitor Cp.

The source capacitor Cs1 is charged with ½ sustain voltage Vs/2 whose magnitude corresponds to half value of the sustain voltage Vs. The first inductor L1, which has a constant inductance, forms a resonance circuit along with the panel capacitor Cp.

For this purpose, the first switch SW1 to the fourth switch SW4 control the flow of current. At this time, the first switch SW1 to the fourth switch SW4 are provided with internal diodes, respectively, to control the flow of current.

On the other hand, the first diode D1 serves to prevent reverse current flow from the panel capacitor Cp as the voltage charged to the source capacitor Cs1 is supplied to the panel capacitor Cp, and the second diode D2 serves to prevent reverse current flow from the source capacitor Cs1 as the voltage charged to the panel capacitor Cp is recovered to the source capacitor Cs1.

The sustain voltage supply unit 6 supplies a sustain voltage Vs to a scan electrode Y of the panel capacitor Cp during a set up period and sustain period of a reset period. The sustain voltage supply unit 6 comprises a third switch SW3 connected between the sustain voltage source Vs and the second node N2.

The ground voltage supply unit 8 supplies a ground voltage GND to the scan electrode Y of the panel capacitor Cp during the sustain period. The ground voltage supply unit 8 comprises a fourth switch SW4 connected between the ground voltage source GND and the second node N2.

FIG. 2 is timing diagrams and waveform diagrams showing on/off timings of the switches and output waveform of the panel capacitor shown in FIG. 1.

Referring to FIG. 2, assuming that the panel capacitor Cp is charged with 0V and at the same time the source capacitor Cs1 is charged with ½ sustain voltage Vs/2 before a period t1, and an operational process will be described in detail.

In the period t1, the first switch SW1 is turned on to form a current path running from the source capacitor Cs1 through the first switch SW1, the first diode D1, the first inductor L1 to the panel capacitor Cp.

Thus, the ½ sustain voltage Vs/2 charged to the source capacitor Cs1 is supplied to the scan electrode Y of the panel capacitor Cp. At this time, the first inductor L1 and panel capacitor Cp together forms a serial resonance circuit, thus charging the panel capacitor Cp with the sustain voltage whose magnitude is two times as much as the voltage supplied from the source capacitor Cs1.

In a period t2, the first switch SW1 is turn off and the third switch SW3 is turned on. Accordingly, the sustain voltage Vs from the sustain voltage source Vs is supplied to the scan electrode Y of the panel capacitor Cp. At this time, the panel capacitor Cp sustains the sustain voltage Vs during the period t2.

On the other hand, since the voltage of the panel capacitor Cp rose up to the sustain voltage Vs during the period t1, a driving power is minimized which is needed to be supplied from the exterior so as to generate a sustain discharge.

In a period t3, the third switch SW3 is turn off and the second switch SW2 is turned on. Accordingly, a current path is formed running from the panel capacitor Cp through the first inductor L1 and the second diode D2 to the source capacitor Cs1, and thus the voltage charged to the panel capacitor Cp is recovered to the source capacitor Cs1. At this time, the source capacitor Cs1 is charged with ½ sustain voltage Vs/2.

After the period t3, the third switch SW3 is turn off and the fourth switch SW4 is turned on.

Thus, the scan electrode Y of the panel capacitor Cp is supplied with the ground voltage GND. At this time, the panel capacitor Cp sustains the ground voltage GND while sustain pulses are supplied to the sustain electrode Z.

On the other hand, the second energy recovery device 12 is operated alternately to the first energy recovery device 2, which supplies sustain pulses to the sustain electrode Z of the panel capacitor Cp.

Therefore, the panel capacitor Cp is supplied with sustain pulses of different polarities. As such, the panel capacitor Cp is supplied with the sustain pulses of different polarities, creating a sustain discharge in discharge cells.

In the energy recovery device of the conventional PDP, however, the first inductor L1 is fixed to have a constant value, which serves to control a charging time for charging the panel capacitor Cp with a sustain voltage Vs and a discharging time for discharging the energy stored in the panel capacitor Cp. Therefore, the energy recovery device of the conventional PDP has a demerit in that in a case where the charging time or discharging time vary with a screen pattern or lord of the PDP, charging/discharging efficiencies may be changed or a margin of the PDP may be reduced accordingly.

That is, although efficiency may be adjusted in the maximum range at any point, the variation of the screen pattern or load of the PDP may give rise to the change of the charging/discharging times of the panel capacitor Cp, which in turn causes the change of the efficiency and margin of the PDP, thus making screen unstable.

### SUMMARY OF THE INVENTION

Accordingly, an object of the present invention is to solve at least the problems and disadvantages of the background art.

Embodiments of the present invention provide an energy recovery device of a plasma display panel, which can improve efficiency and margin.

A plasma display apparatus according to an embodiment of the present invention comprises a plasma display panel comprising an electrode and an energy recovery/supply unit comprising a variable inductor located over a supply path of a pulse applied to the electrode.

A plasma display apparatus according to another embodiment of the present invention comprises a plasma display panel comprising an electrode, a sustain voltage supply unit for applying a sustain voltage to supply a sustain pulse to the electrode and an energy recovery/supply unit for maintaining to a constant slope of the sustain pulse supplied to the electrode.

A plasma display apparatus according to still another embodiment of the present invention comprises a plasma display panel comprising an electrode and an energy recovery/supply unit comprising an inductor located over charging/discharging paths of a pulse applied to the electrode, whose inductance varies according to a screen pattern or load of the plasma display panel.

A driving method of a plasma display apparatus according to still another embodiment of the present invention comprises the steps of varying an inductance of an inductor over charging/discharging paths according to a screen pattern or load of a plasma display panel and making constant a rising/falling slope of the sustain pulse.

The present invention can improve margin of a plasma display panel. In addition, the present invention can raise discharge efficiency and energy recovery efficiency by making a charging time of a panel capacitor faster than a discharging time of the panel capacitor.

### BRIEF DESCRIPTION OF THE DRAWINGS

The invention will be described in detail with reference to the following drawings in which like numerals refer to like elements.

FIG. 1 is a circuit diagram showing an energy recovery circuit for a general PDP.

FIG. 2 is timing diagrams and waveform diagrams showing on/off timings of the switches and output waveform of the panel capacitor shown in FIG. 1.

FIG. 3 is a circuit diagram showing an energy recovery device of a plasma display apparatus according to a first embodiment of the present invention.

FIG. 4 is a view for illustrating a variation of a charging/discharging time of a panel capacitor according to a screen pattern or load of a PDP.

FIG. 5 is a circuit diagram showing an energy recovery device of a plasma display apparatus according to a second embodiment of the present invention.

FIG. 6 is a circuit diagram showing an energy recovery device of a plasma display apparatus according to a third embodiment of the present invention.

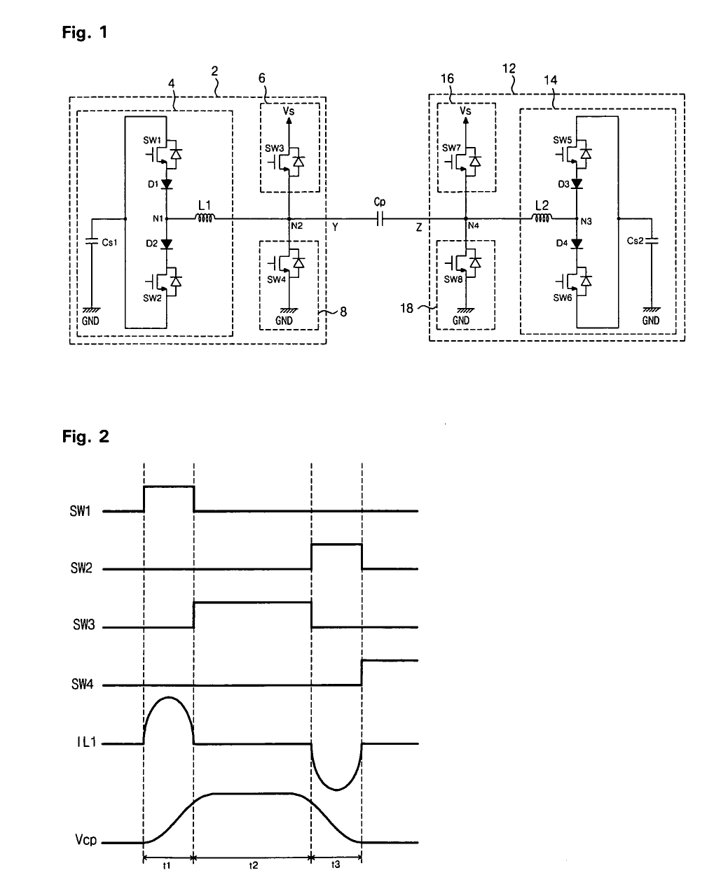

### DETAILED DESCRIPTION OF PREFERRED EMBODIMENTS

Preferred embodiments of the present invention will be described in a more detailed manner with reference to the drawings.

A plasma display apparatus according to an embodiment of the present invention comprises a plasma display panel comprising an electrode and an energy recovery/supply unit comprising a variable inductor located over a supply path of a pulse applied to the electrode.

A plasma display apparatus according to another embodiment of the present invention comprises a plasma display panel comprising an electrode, a sustain voltage supply unit for applying a sustain voltage to supply a sustain pulse to the electrode and an energy recovery/supply unit for maintaining to a constant slope of the sustain pulse supplied to the electrode.

The energy recovery/supply unit comprises a source capacitor for supplying/recovering energy to/from the plasma display panel and a variable inductor connected between the source capacitor and the electrode, for maintaining to the constant slope of the sustain pulse.

The energy recovery/supply unit comprises a source capacitor for supplying/recovering energy to/from the plasma display panel, a first inductor connected between the source capacitor and the electrode of the plasma display panel, a second inductor connected between the source capacitor and the first inductor, and a third inductor connected in parallel with the second inductor between the source capacitor and the first inductor.

Preferably, the inductances of the first inductor, the second inductor and the third inductor vary.

Preferably, the inductances of the first inductor, the second inductor and the third inductor are equal to each other.

Preferably, the inductances of the first inductor, the second inductor and the third inductor are different from each other.

Preferably, the inductances of the second inductor is more than the inductances of of the third inductor.

Preferably, the inductances of the first inductor remains constant, and the inductances of the second inductor and the third inductor vary.

Preferably, the inductances of the first inductor, the second inductor and the third inductor are equal to each other.

Preferably, the inductances of the first inductor, the second inductor and the third inductor are different from each other.

Preferably, the inductances of the second inductor is more than the inductances of of the third inductor.

Preferably, the inductances of the first inductor varies, and the inductances of the second inductor and the third inductor remain constant.

Preferably, the inductances of the first inductor, the second inductor and the third inductor are equal to each other.

Preferably, the inductances of the first inductor, the second inductor and the third inductor are different from each other.

Preferably, the inductances of the second inductor is more than the inductances of the third inductor.

A plasma display apparatus according to still another embodiment of the present invention comprises a plasma display panel comprising an electrode and an energy recovery/supply unit comprising an inductor located over charging/discharging paths of a pulse applied to the electrode, whose inductance varies according to a screen pattern or load of the plasma display panel.

The energy recovery/supply unit comprises a source capacitor for supplying/recovering energy to/from the plasma display panel, a second inductor connected between the source capacitor and the electrode of the plasma display panel over a path of supplying the energy of the plasma display panel and a third inductor connected in parallel with the second inductor between the source capacitor and the electrode of the plasma display panel over a path of recovering the energy of the plasma display panel.

A driving method of a plasma display apparatus according to still another embodiment of the present invention comprises the steps of varying an inductance of an inductor over charging/discharging paths according to a screen pattern or load of a plasma display panel and making constant a rising/falling slope of the sustain pulse.

Preferably, the inductor is a variable inductor.

Hereinafter, exemplary embodiments of the present invention will be described in detail with reference to the attached drawings.

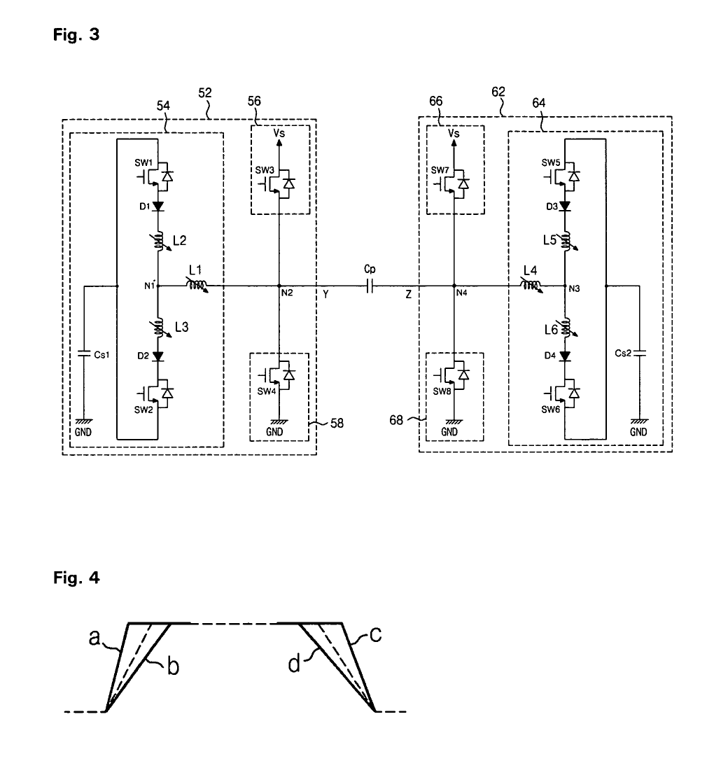

FIG. 3 is a circuit diagram showing an energy recovery device of a plasma display apparatus according to a first embodiment of the present invention.

Referring to FIG. 3, energy recovery devices 52, 62 for a plasma display panel according to a first embodiment of the present invention are symmetrically installed with respect to a panel capacitor Cp.

At this time, a first energy recovery device 52 supplies sustain pulses to the scan electrode Y, and a second energy recovery device 62, operated alternately with the first energy recovery device 52, supplies sustain pulses to the sustain electrode Z.

Herein, the first energy recovery device 52 and the second energy recovery device 62 comprise the same components, respectively. Therefore, the construction of the energy recovery devices 52, 62 of the plasma display apparatus according to the first embodiment of the present invention will be described hereinafter with reference to the first energy recovery device 52.

The first energy recovery device 52 comprises an energy recovery/supply unit 54 for recovering a reactive power not to contribute to a discharge from a plasma display panel (hereinafter, referred to as ‘PDP’) and supplying the recovered energy to a panel capacitor Cp, a sustain voltage supply unit 56 for supplying a sustain voltage Vs to a scan electrode Y of the panel capacitor Cp, and a ground voltage supply unit 58 for supplying a ground voltage GND to the scan electrode Y of the panel capacitor Cp.

The energy recovery/supply unit 54 is connected to the scan electrode Y of the panel capacitor Cp, which serves to recover energy of the reactive power not to contribute to the discharge from the panel capacitor Cp, and at the same time to supply the recovered energy to the scan electrode Y of the panel capacitor Cp.

That is, the energy recovery/supply unit 54 recovers the energy stored in the panel capacitor Cp by the sustain voltage Vs, and supplies the recovered energy to the scan electrode Y of the panel capacitor Cp.

The energy recovery/supply unit 54 comprises a source capacitor Cs1 for storing the energy recovered from the scan electrode Y of the panel capacitor Cp, a first inductor L1 connected between the source capacitor Cs1 and the scan electrode Y of the panel capacitor Cp, a first switch SW1 and a second switch SW2 connected in parallel between the source capacitor Cs1 and the first inductor L1, a first diode D1 and a second inductor L2 connected in serial between the first switch SW1 and the first inductor L1, and a third inductor L3 and a second diode D2 connected in serial between a first node N1, a common node between the first inductor L1 and the second inductor L2, and the second switch SW2.

The source capacitor Cs1 serves to recover the energy charged to the panel capacitor Cp and at the same time to re-supply the recovered energy to the scan electrode Y of the panel capacitor Cp.

The source capacitor Cs1 is charged with ½ sustain voltage Vs/2 whose magnitude corresponds to half value of the sustain voltage Vs.

The first inductor L1 to the third inductor L3 forms a resonant roof along with the panel capacitor Cp depending on switching of the first switch SW1 and the second switch SW2.

At this time, the first inductor L1 and the second inductor L2 supplies the energy from the source capacitor Cs1 to the panel capacitor Cp by LC resonance between the panel capacitor Cp and the inductors L1, L2, and the first inductor L1 and the third inductor L3 recovers the energy stored to the panel capacitor Cp to the source capacitor Cs1 by LC resonance between the inductors L1, L3 and the panel capacitor Cp.

The inductances of the first inductor L1 to the third inductor L3 are equal to each other, or are different from each other. In addition, the second inductor L2 has inductance equal to or above the inductance of the third inductor L3.

At this time, if the inductances of the second inductor L2 and the third inductor L3 are identical, charging/discharging times of the panel capacitor Cp are identical, and if the inductances of the second inductor L2 is more than the inductances of the third inductor L3, the charging of the panel capacitor Cp becomes faster than the discharging time thereof.

Herein, the first inductor L1 allows a region where discharge efficiency and energy recovery efficiency may be controlled to be extended by causing the inductance over a discharge current path and a recovery current path to be large, the second inductor L2 controls a charging time of the panel capacitor Cp, and the third inductor L3 controls a discharging time of the panel capacitor Cp.

Thus, variable inductors are employed as the first inductor L1 to the third inductor L3, which can vary inductance. Accordingly, the discharge efficiency and energy recovery efficiency may be kept constant all the time, since the inductances of the first to the third inductors L1-L3 may be varied although the screen pattern is changed or the load of the panel capacitor Cp is varied.

As such, the present invention may improve the discharge efficiency, energy recovery efficiency and margin of the panel capacitor Cp by using the first to the third inductors L1-L3 capable of changing inductance.

The first switch SW1 is connected between the source capacitor Cs1 and the first diode D1, which forms a current path so that the energy stored to the source capacitor Cs1 may be supplied to the panel capacitor Cp by a first switching control signal from a timing controller (not shown).

The second switch SW2 is connected between the source capacitor Cs1 and the second diode D2, which forms a current path so that the energy of reactive power not to contribute to a discharge may be supplied from the panel capacitor Cp to the source capacitor Cs1 by a second switching control signal from the timing controller (not shown).

The first diode D1 is connected between the first switch SW1 and the second inductor L2, which prevents reverse current flow from the scan electrode Y of the panel capacitor Cp as the energy from the source capacitor Cs1 is supplied to the scan electrode Y of the panel capacitor Cp.

The second diode D2 is connected between the third inductor L3 and the second switch SW2, which prevents reverse current flow from the source capacitor Cs1 as the energy from the panel capacitor Cp is recovered to the source capacitor Cs1.

The sustain voltage supply unit 56 is connected to the second node N2, which supplies a sustain voltage Vs to the scan electrode Y of the panel capacitor Cp during a set up period and sustain period of a reset period. The sustain voltage supply unit 56 comprises a sustain voltage source Vs and the third switch SW3.

The third switch SW3 is connected between the sustain voltage source Vs and the second node N2, which provides an electrical connection from the sustain voltage source Vs to the second node N2 in response to a third switching signal from the timing controller (not shown).

Thus, the sustain voltage Vs is transmitted to the second node N2 during the set up period and sustain period of the reset period.

The ground voltage supply unit 58 is connected to the second node N2, which supplies a ground voltage GND to the scan electrode Y alternately with the sustain voltage supply unit 56 during the sustain period. The sustain voltage supply unit 58 comprises a ground voltage source GND and the fourth switch SW4.

The fourth switch SW4 is connected between the fourth node N4 and the ground voltage source GND, which provides an electrical connection from the ground voltage source GND to the second node N2 in response to a fourth switching signal from the timing controller (not shown).

Thus, the ground voltage GND is transmitted to the second node N2 during the sustain period. The fourth switch SW4 is operated alternately with the third switch SW3 during the sustain period. That is, the sustain voltage Vs and ground voltage GND are alternately supplied to the second node N2 during the sustain period.

FIG. 4 is a view for illustrating a variation of a charging/discharging time of a panel capacitor according to a screen pattern or load of a PDP.

Referring to FIG. 4, if a screen pattern or load of the panel capacitor Cp is constant, then the panel capacitor Cp charges/discharges the sustain voltage Vs with a slope represented by dotted lines.

In a case where the screen pattern or load of the panel capacitor Cp decreases, however, the charging time/discharging time of the panel capacitor Cp become faster as ‘a’ and ‘c’, and in a case where the screen pattern or load of the panel capacitor Cp increases, the charging time/discharging time of the panel capacitor Cp become slower as ‘b’ and ‘d’.

However, the inductances of the first inductor L1 to third inductor L3, which control the charging time/discharging time of the panel capacitor Cp, may be varied in the plasma display apparatus according to the first embodiment of the present invention. Therefore, in a case where the screen pattern or load of the panel capacitor Cp increases, it is possible to shift the slope of the charging/discharging times of the panel capacitor Cp to the slope as dotted lines by increasing the inductances of the first inductor L1 to the third inductor L3.

In addition, in a case where the screen pattern or load of panel capacitor Cp decreases, it is possible to shift the slope of the charging/discharging times of the panel capacitor Cp to the slope as dotted lines by reducing the inductance of the first inductor L1 to the third inductor L3.

At this time, it is also possible to shift the slope of the charging/discharging times of the panel capacitor Cp to the slope as dotted lines by changing the inductance of only the second and third inductors L2 and L3.

At this time, the charging time of the panel capacitor Cp is shorter than the discharging time of the panel capacitor Cp.

Thus, the energy recovery device of the plasma display apparatus according to the first embodiment of the present invention may sustain the charging/discharging times of the panel capacitor Cp without respect to the screen pattern or load of panel capacitor Cp.

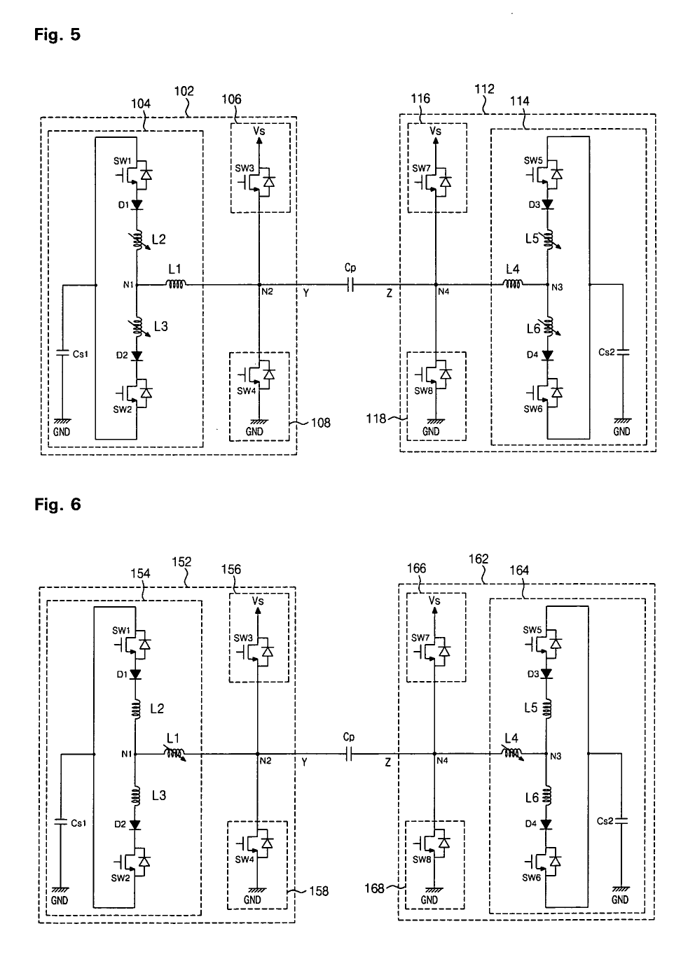

FIG. 5 is a circuit diagram showing an energy recovery device of a plasma display apparatus according to a second embodiment of the present invention.

Referring to FIG. 5, energy recovery devices 102, 112 for a plasma display panel according to a second embodiment of the present invention are symmetrically installed with respect to a panel capacitor Cp.

At this time, a first energy recovery device 102 supplies sustain pulses to the scan electrode Y, and a second energy recovery device 112, operated alternately with the first energy recovery device 102, supplies sustain pulses to the sustain electrode Z.

Herein, the first energy recovery device 102 and the second energy recovery device 112 comprise the same components, respectively. Therefore, the construction of the energy recovery devices 102, 112 of the plasma display apparatus according to the second embodiment of the present invention will be described hereinafter with reference to the first energy recovery device 102.

The first energy recovery device 102 comprises an energy recovery/supply unit 104 for recovering a reactive power not to contribute to a discharge from a PDP and supplying the recovered energy to a panel capacitor Cp, a sustain voltage supply unit 106 for supplying a sustain voltage Vs to a scan electrode Y of the panel capacitor Cp, and a ground voltage supply unit 108 for supplying a ground voltage GND to the scan electrode Y of the panel capacitor Cp.

Herein, the other components except for the energy recovery/supply unit 104 are the same as those of the energy recovery device of the plasma display panel according to the first embodiment of the present invention, and the detailed explanation for the other components except for the energy recovery/supply unit 104 will be substituted by the above descriptions.

The energy recovery/supply unit 104 is connected to the scan electrode Y of the panel capacitor Cp, which serves to recover energy of the reactive power not to contribute to the discharge from the panel capacitor Cp, and at the same time to supply the recovered energy to the scan electrode Y of the panel capacitor Cp.

That is, the energy recovery/supply unit 104 recovers the energy stored in the panel capacitor Cp by the sustain voltage Vs, and supplies the recovered energy to the scan electrode Y of the panel capacitor Cp.

The energy recovery/supply unit 104 comprises a source capacitor Cs1 for storing the energy recovered from the scan electrode Y of the panel capacitor Cp, a first inductor L1 connected between the source capacitor Cs1 and the scan electrode Y of the panel capacitor Cp, a first switch SW1 and a second switch SW2 connected in parallel between the source capacitor Cs1 and the first inductor L1, a first diode D1 and a second inductor L2 connected in serial between the first switch SW1 and the first inductor L1, and a third inductor L3 and a second diode D2 connected in serial between a first node N1, a common node between the first inductor L1 and the second inductor L2, and the second switch SW2.

The source capacitor Cs1 serves to recover the energy charged to the panel capacitor Cp and at the same time to re-supply the recovered energy to the scan electrode Y of the panel capacitor Cp.

The source capacitor Cs1 is charged with ½ sustain voltage Vs/2 whose magnitude corresponds to half value of the sustain voltage Vs.

The first inductor L1 to the third inductor L3 forms a resonant roof along with the panel capacitor Cp depending on switching of the first switch SW1 and the second switch SW2.

At this time, the first inductor L1 and the second inductor L2 supplies the energy from the source capacitor Cs1 to the panel capacitor Cp by LC resonance between the panel capacitor Cp and the inductors L1, L2, and the first inductor L1 and the third inductor L3 recovers the energy stored to the panel capacitor Cp to the source capacitor Cs1 by LC resonance between the inductors L1, L3 and the panel capacitor Cp.

The inductances of the first inductor L1 to the third inductor L3 all are equal to each other, or are different from each other.

In addition, the second inductor L2 has inductance equal to or above the inductance of the third inductor L3. At this time, if the inductances of the second inductor L2 and the third inductor L3 are identical, charging/discharging times of the panel capacitor Cp are identical, and if the inductances of the second inductor L2 is more than the inductances of the third inductor L3, the charging time of the panel capacitor Cp becomes faster than the discharging time of the panel capacitor Cp.

Herein, the first inductor L1 allows a region where discharge efficiency and energy recovery efficiency may be controlled to be extended by causing the inductance over a discharge current path and a recovery current path to be large, the second inductor L2 controls a charging time of the panel capacitor Cp, and the third inductor L3 controls a discharging time of the panel capacitor Cp.

At this time, the inductances of the first inductor L1 remains constant, and variable inductors capable of changing the inductance are employed as the second inductor L2 and the third inductor L3.

Therefore, although the screen pattern or load of panel capacitor Cp is changed, the discharge efficiency and energy recovery efficiency may be kept constant all the time since the charging time and discharging time of the panel capacitor Cp can be adjusted constantly by varying the inductance of the second inductor L2 and the third inductor L3.

As such, the plasma display apparatus according to the second embodiment of the present invention may improve the discharge efficiency, energy recovery efficiency and margin of the panel capacitor Cp by using the second to the third inductors L2, L3 capable of changing inductance. Herein, the first inductor L1 may be omitted.

The first switch SW1 is connected between the source capacitor Cs1 and the first diode D1, which forms a current path so that the energy stored to the source capacitor Cs1 may be supplied to the panel capacitor Cp by a first switching control signal from a timing controller (not shown).

The second switch SW2 is connected between the source capacitor Cs1 and the second diode D2, which forms a current path so that the energy of reactive power not to contribute to a discharge may be supplied from the panel capacitor Cp to the source capacitor Cs1 by a second switching control signal from the timing controller (not shown).

The first diode D1 is connected between the first switch SW1 and the second inductor L2, which prevents reverse current flow from the scan electrode Y of the panel capacitor Cp as the energy from the source capacitor Cs1 is supplied to the scan electrode Y of the panel capacitor Cp.

The second diode D2 is connected between the third inductor L3 and the second switch SW2, which prevents reverse current flow from the source capacitor Cs1 as the energy from the panel capacitor Cp is recovered to the source capacitor Cs1.

FIG. 6 is a circuit diagram showing an energy recovery device of a plasma display apparatus according to a third embodiment of the present invention.

Referring to FIG. 6, energy recovery devices 152, 162 for a plasma display panel according to a third embodiment of the present invention are symmetrically installed with respect to a panel capacitor Cp.

At this time, a first energy recovery device 152 supplies sustain pulses to the scan electrode Y, and a second energy recovery device 162, operated alternately with the first energy recovery device 152, supplies sustain pulses to the sustain electrode Z.

Herein, the first energy recovery device 152 and the second energy recovery device 162 comprise the same components, respectively. Therefore, the construction of the energy recovery devices 152, 162 of the plasma display apparatus according to the third embodiment of the present invention will be described hereinafter with reference to the first energy recovery device 152.

The first energy recovery device 152 comprises an energy recovery/supply unit 154 for recovering a reactive power not to contribute to a discharge from a PDP and supplying the recovered energy to a panel capacitor Cp, a sustain voltage supply unit 156 for supplying a sustain voltage Vs to a scan electrode Y of the panel capacitor Cp, and a ground voltage supply unit 158 for supplying a ground voltage GND to the scan electrode Y of the panel capacitor Cp.

Herein, the other components except for the energy recovery/supply unit 154 are the same as those of the energy recovery device of the plasma display apparatus according to the first embodiment of the present invention, and thus the detailed explanation will be substituted by the above descriptions.

The energy recovery/supply unit 154 is connected to the scan electrode Y of the panel capacitor Cp, which serves to recover energy of the reactive power not to contribute to the discharge from the panel capacitor Cp, and at the same time to supply the recovered energy to the scan electrode Y of the panel capacitor Cp.

That is, the energy recovery/supply unit 154 recovers the energy stored in the panel capacitor Cp by the sustain voltage Vs, and supplies the recovered energy to the scan electrode Y of the panel capacitor Cp.

The energy recovery/supply unit 154 comprises a source capacitor Cs1 for storing the energy recovered from the scan electrode Y of the panel capacitor Cp, a first inductor L1 connected between the source capacitor Cs1 and the scan electrode Y of the panel capacitor Cp, a first switch SW1 and a second switch SW2 connected in parallel between the source capacitor Cs1 and the first inductor L1, a first diode D1 and a second inductor L2 connected in serial between the first switch SW1 and the first inductor L1, and a third inductor L3 and a second diode D2 connected in serial between a first node N1, a common node between the first inductor L1 and the second inductor L2, and the second switch SW2.

The source capacitor Cs1 serves to recover the energy charged to the panel capacitor Cp and at the same time to re-supply the recovered energy to the scan electrode Y of the panel capacitor Cp. The source capacitor Cs1 is charged with ½ sustain voltage Vs/2 whose magnitude corresponds to half value of the sustain voltage Vs.

The first inductor L1 to the third inductor L3 forms a resonant roof along with the panel capacitor Cp depending on switching of the first switch SW1 and the second switch SW2.

At this time, the first inductor L1 and the second inductor L2 supplies the energy from the source capacitor Cs1 to the panel capacitor Cp by LC resonance between the panel capacitor Cp and the inductors L1, L2, and the first inductor L1 and the third inductor L3 recovers the energy stored to the panel capacitor Cp to the source capacitor Cs1 by LC resonance between the inductors L1, L3 and the panel capacitor Cp.

The inductances of the first inductor L1 to the third inductor L3 all are equal to each other, or are different from each other.

In addition, the second inductor L2 has inductance equal to or above the inductance of the third inductor L3. At this time, if the inductances of the second inductor L2 and the third inductor L3 are identical, charging/discharging times of the panel capacitor Cp are identical, and if the inductances of the second inductor L2 is more than the inductances of the third inductor L3, the charging time of the panel capacitor Cp becomes faster than the discharging time of the panel capacitor Cp.

Herein, the first inductor L1 allows a region where discharge efficiency and energy recovery efficiency may be controlled to be extended by causing the inductance over a discharge current path and a recovery current path to be large, the second inductor L2 controls a charging time of the panel capacitor Cp, and the third inductor L3 controls a discharging time of the panel capacitor Cp.

At this time, the inductances of the second inductor L2 and the third inductor L3 remains constant. And, a variable inductor is employed as the first inductor L1, and the second inductor L2 and the third inductor L3 have constant inductances.

Therefore, although the screen pattern is changed or load of panel capacitor Cp is varied, the charging time and discharging time of the panel capacitor Cp may be adjusted constantly since the inductances of the discharge current path and charging current path are adjusted by varying the inductance of the first inductor L1.

Thus, the discharge efficiency and energy recovery efficiency may be kept constant all the time. As such, the present invention may improve the discharge efficiency, energy recovery efficiency and margin of the panel capacitor Cp by using the first inductors L1 capable of changing inductance. Herein, the second inductor L2 and the third inductor L3 may be omitted.

The first switch SW1 is connected between the source capacitor Cs1 and the first diode D1, which forms a current path so that the energy stored to the source capacitor Cs1 may be supplied to the panel capacitor Cp by a first switching control signal from a timing controller (not shown).

The second switch SW2 is connected between the source capacitor Cs1 and the second diode D2, which forms a current path so that the energy of reactive power not to contribute to a discharge may be supplied from the panel capacitor Cp to the source capacitor Cs1 by a second switching control signal from the timing controller (not shown).

The first diode D1 is connected between the first switch SW1 and the second inductor L2, which prevents reverse current flow from the scan electrode Y of the panel capacitor Cp as the energy from the source capacitor Cs1 is supplied to the scan electrode Y of the panel capacitor Cp.

The second diode D2 is connected between the third inductor L3 and the second switch SW2, which prevents reverse current flow from the source capacitor Cs1 as the energy from the panel capacitor Cp is recovered to the source capacitor Cs1.

The present invention can improve margin of a plasma display panel. In addition, the present invention can raise discharge efficiency and energy recovery efficiency by making a charging time of a panel capacitor faster than a discharging time of the panel capacitor.

The invention being thus described, it will be obvious that the same may be varied in many ways. Such variations are not to be regarded as a departure from the spirit and scope of the invention, and all such modifications as would be obvious to one skilled in the art are intended to be comprised within the scope of the following claims.

What is claimed is:

1. A plasma display apparatus, comprising:
a plasma display panel comprising an electrode; and
an energy recovery/supply unit comprising a variable inductor located over a supply path of a pulse applied to the electrode.

2. A plasma display apparatus, comprising:
a plasma display panel comprising an electrode;
a sustain voltage supply unit for applying a sustain voltage to supply a sustain pulse to the electrode; and
an energy recovery/supply unit for maintaining to a constant slope of the sustain pulse supplied to the electrode.

3. The plasma display apparatus as claimed in claim 2, wherein the energy recovery/supply unit comprises:
a source capacitor for supplying/recovering energy to/from the plasma display panel; and
a variable inductor connected between the source capacitor and the electrode, for maintaining to the constant slope of the sustain pulse.

4. The plasma display apparatus as claimed in claim 2, wherein the energy recovery/supply unit comprises:
a source capacitor for supplying/recovering energy to/from the plasma display panel;
a first inductor connected between the source capacitor and the electrode of the plasma display panel;
a second inductor connected between the source capacitor and the first inductor; and
a third inductor connected in parallel with the second inductor between the source capacitor and the first inductor.

5. The plasma display apparatus as claimed in claim 4, wherein
the inductances of the first inductor, the second inductor and the third inductor vary.

6. The plasma display apparatus as claimed in claim 5, wherein
the inductances of the first inductor, the second inductor and the third inductor are equal to each other.

7. The plasma display apparatus as claimed in claim 5, wherein
the inductances of the first inductor, the second inductor and the third inductor are different from each other.

8. The plasma display apparatus as claimed in claim 7, wherein
the inductances of the second inductor is more than the inductances of of the third inductor.

9. The plasma display apparatus as claimed in claim 4, wherein
the inductances of the first inductor remains constant, and the inductances of the second inductor and the third inductor vary.

10. The plasma display apparatus as claimed in claim 9, wherein
the inductances of the first inductor, the second inductor and the third inductor are equal to each other.

11. The plasma display apparatus as claimed in claim 9, wherein
the inductances of the first inductor, the second inductor and the third inductor are different from each other.

12. The plasma display apparatus as claimed in claim 11, wherein
the inductances of the second inductor is more than the inductances of of the third inductor.

13. The plasma display apparatus as claimed in claim 4, wherein
the inductances of the first inductor varies, and the inductances of the second inductor and the third inductor remain constant.

14. The plasma display apparatus as claimed in claim 13, wherein
the inductances of the first inductor, the second inductor and the third inductor are equal to each other.

15. The plasma display apparatus as claimed in claim 13, wherein
the inductances of the first inductor, the second inductor and the third inductor are different from each other.

16. The plasma display apparatus as claimed in claim 15, wherein
the inductances of the second inductor is more than the inductances of the third inductor.

17. A plasma display apparatus, comprising:
a plasma display panel comprising an electrode; and
an energy recovery/supply unit comprising an inductor located over charging/discharging paths of a pulse appL1ed to the electrode, whose inductance varies according to a screen pattern or load of the plasma display panel.

18. The plasma display apparatus as claimed in claim 17, wherein
the energy recovery/supply unit comprises:
a source capacitor for supplying/recovering energy to/from the plasma display panel;
a second inductor connected between the source capacitor and the electrode of the plasma display panel over a path of supplying the energy of the plasma display panel; and
a third inductor connected in parallel with the second inductor between the source capacitor and the electrode of the plasma display panel over a path of recovering the energy of the plasma display panel.

19. A driving method of a plasma display apparatus comprising the steps of:
varying an inductance of an inductor over charging/discharging paths according to a screen pattern or load of a plasma display panel; and
making constant a rising/falling slope of the sustain pulse.

20. The driving method of the plasma display apparatus as claimed in claim 19, wherein
the inductor is a variable inductor.
